(19) United States
(12) Patent Application Publication
(10) Pub. No.: US 2017/0218668 A1
(43) Pub. Date: Aug. 3, 2017

(54) LATCH HANDLE FOR VEHICLE STORAGE TRUNK

(71) Applicants: Peter V. Amenda, Hudson, WI (US); Jay N. Rogers, Hudson, WI (US)

(72) Inventors: Peter V. Amenda, Hudson, WI (US); Jay N. Rogers, Hudson, WI (US)

(21) Appl. No.: 15/011,006

(22) Filed: Jan. 29, 2016

(51) Int. Cl. E05B 85/10; B60R 5/00

(52) U.S. Cl. CPC E05B 85/10; B60R 5/00

(57) ABSTRACT

A latchable vehicle storage trunk includes a latch handle configured to be grasped by a hand of a user to operate the storage trunk between open and closed positions.

### TECHNICAL FIELD

The present disclosure relates generally to vehicle storage trunks and, more particularly, to latch handles for vehicle storage trunks.

### BACKGROUND

Vehicle storage compartments, such as a bins or trunks, are often operable between open and closed positions for accessing and securing items within the compartment. Vehicle storage compartments for motorcycles and other open cab vehicles may include latches for securing the compartment in a closed position.

### SUMMARY

The present application discloses one or more of the features recited in the appended claims and/or the following features which, alone or in any combination, may comprise patentable subject matter:

According to one aspect of the disclosure, a handle for a vehicle storage bin may include an elongate body extending between a first end and a second end and having a top surface and a bottom surface opposite the top surface, a mast extending from the top surface of the body at a location between the first and second ends, the mast including an attachment hole extending therethrough, and a handle wing extending from the body. The handle wing is configured for grasping by a hand of a user to open and close the vehicle storage bin.

In some embodiments, the handle may include a flange extending from the bottom surface of the body proximate to the first end of the body.

In some embodiments, the flange may include a leg extending from the bottom surface of the body in a first direction and a foot extending from an end of the leg in a second direction that is orthogonal to the first direction.

In some embodiments, the flange may define a receptacle sized to receive a rim of a lid of the vehicle storage bin.

In some embodiments, the handle may include a second flange including a leg extending from the bottom surface of the body in the first direction and a foot extending from an end of the leg of the second flange in the second direction.

In some embodiments, the flange may be a first flange, and the second flange extends from the body proximate to the second end of the body spaced apart from the first flange.

In some embodiments, an opening sized to receive an upper receiver of a latch of the vehicle storage bin may be defined between the first flange and the second flange.

In some embodiments, the attachment hole may be defined by a pair of opposing flat surfaces of the mast and a pair of opposing curved surfaces of the mast.

In some embodiments, the attachment hole may be configured to receive a lock tumbler assembly of the vehicle storage bin.

According to another aspect of the disclosure, a handle for a vehicle storage bin may include an elongate body extending between a first end and a second end and defining a first axis, a receptacle defined by the body, and a handle wing extending from the body at the first end. The handle wing is configured for engagement by a hand of a user to open and close the vehicle storage bin.

In some embodiments, the body may include a flange that defines the receptacle.

In some embodiments, the flange may include a leg extending from a bottom side of the handle wing in a first direction and a foot extending from an end of the leg in a second direction that is orthogonal to the first direction.

In some embodiments, the flange may include a toe extending from the leg in a third direction parallel to the first direction and the receptacle may be configured to receive a rim of a lid of the vehicle storage bin.

In some embodiments, the flange may be a first flange positioned proximate to the first end, and the body may include a second flange extending from the body and positioned proximate to the second end of the body.

In some embodiments, the body may include a central beam extending between the first and second ends. The central beam may have an upper surface that is configured for engagement by a lower latch receiver of the vehicle storage bin to block opening of the vehicle storage bin.

In some embodiments, the central beam may include a tapered cross-section when viewed along the first axis.

In some embodiments, the central beam may include an attachment hole extending therethrough.

In some embodiments, the central beam may include a rear surface having a curvature shaped to engage an outer surface of a lid of the vehicle storage bin.

In some embodiments, the handle wing may include a rear surface having a curvature shaped to engage the outer surface of the lid of the vehicle storage bin.

According to another aspect of the disclosure, a latchable vehicle storage truck may include a trunk body including a lid and basin together defining a bottom wall, sidewalls, and a top wall, a trunk latch assembly, and a latch handle. The latch handle may include an elongate body, a handle wing extending from the elongate body, and a mounting flange. The body extends between a first end and a second end and may define an attachment hole penetrating therethrough. The handle wing may extend from the elongate body at the first end thereof and is configured for grasping by a hand of a user to open and close the trunk body. The mounting flange may extend from the elongate body beneath the handle wing.

Additional features alone or in combination with any other feature(s), including those listed above and those listed in the claims and those described in detail below, can comprise patentable subject matter. Others will become apparent to those skilled in the art upon consideration of the following detailed description of illustrative embodiments exemplifying the best mode of carrying out the invention as presently perceived.

### BRIEF DESCRIPTION OF THE DRAWINGS

The detailed description particularly refers to the following figures, in which:

FIG. 1 is a perspective view of a latchable vehicle storage trunk;

FIG. 2 is a view similar to FIG. 1 showing the latchable vehicle storage trunk in an open position;

FIG. 3 is a perspective view of a latch handle of the latchable vehicle storage trunk of FIGS. 1 and 2;

FIG. 4 is a rear perspective view of the latch handle of FIG. 3;

FIG. 5 is a side elevation view of the latch handle of FIGS. 3 and 4 showing the lid in cross-section;

FIG. 6 is a front perspective view of the latch handle of FIGS. 3-5;

FIG. 7 is a perspective view of another embodiment of a latchable vehicle storage trunk;

FIG. 8 is a perspective view similar to FIG. 7 of the latchable vehicle storage trunk in an open position;

FIG. 9 is another front perspective view of a latch handle of the latchable vehicle storage trunk of FIGS. 7 and 8;

FIG. 10 is another front perspective view of the latch handle of FIG. 9;

FIG. 11 is a rear cross-sectional perspective view of the latch handle of FIGS. 9 and 10 taken along the line 11-11 in FIG. 9;

FIG. 12 is a side elevation view of the latch handle of FIGS. 9-11; and

FIG. 13 is a top plan view of the latch handle of FIGS. 9-12.

### DETAILED DESCRIPTION OF THE DRAWINGS

While the concepts of the present disclosure are susceptible to various modifications and alternative forms, specific exemplary embodiments thereof have been shown by way of example in the drawings and will herein be described in detail. It should be understood, however, that there is no intent to limit the concepts of the present disclosure to the particular forms disclosed, but on the contrary, the intention is to cover all modifications, equivalents, and alternatives falling within the spirit and scope of the invention.

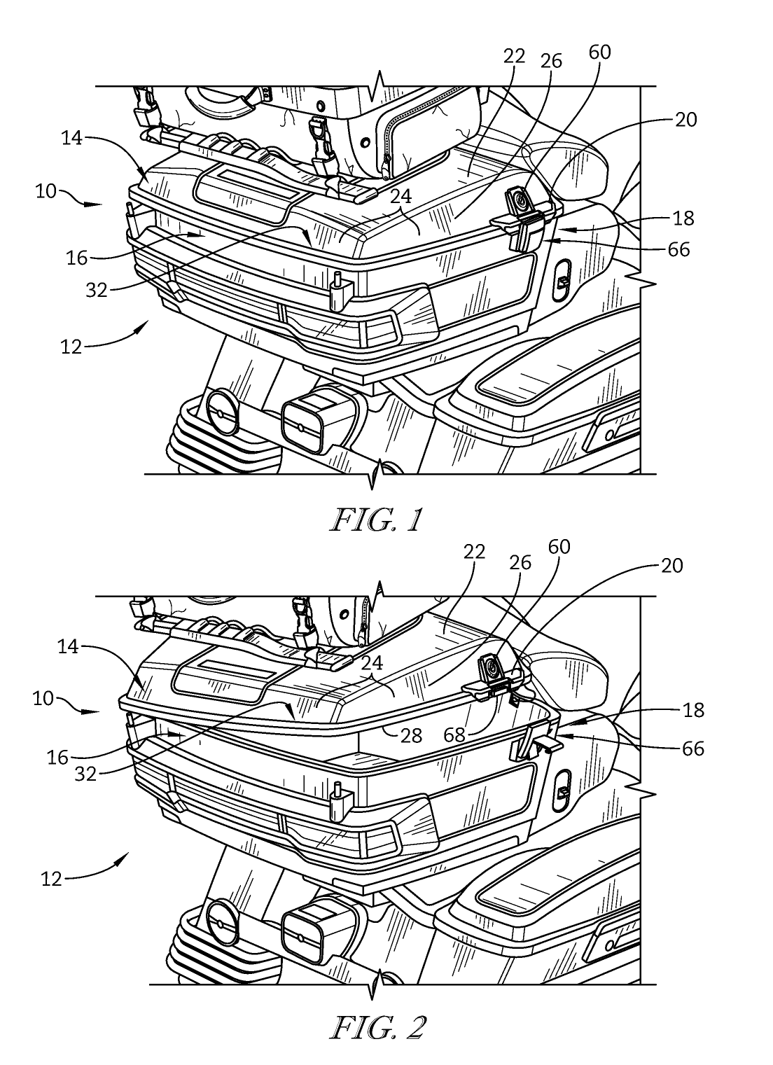

Referring now to FIG. 1, there is shown a latchable vehicle storage trunk 10 for securely storing items. The latchable vehicle storage truck 10 including a trunk body 12 having a lid 14 and a basin 16, a trunk latch assembly 18 for securing the lid 14 and the basin 16 together in a closed position, and a latch handle 20 attached to the lid 14. As described in greater detail below, the latch handle 20 provides an interface for a user's hand to grasp to move the lid 14 between a closed (as shown in FIG. 1) and an open position (as shown in FIG. 2) and the closed position to permit a user to access the interior of the basin 16.

As suggested in FIGS. 1 and 2, a user can unlatch the latch assembly 18, grasp the latch handle 20, and move the lid 14 between the open and closed positions via the latch handle 20. A user thus can open and close the latchable vehicle storage trunk 10 without having to touch parts other than the latch handle 20 such as, for example, the lid 14, which may be painted, polished, and/or otherwise preferably left untouched. The latch handle 20 provides ease of operating the trunk 10 and permits one-handed operation while reducing the risk of imposing scratches, smudges, and other contact-related issues on other components of trunk 10.

As shown in FIGS. 1, 2, and 5, the lid 14 includes a top 22 and a number of sidewalls 24. The sidewalls 24 are each attached to the top 22 and extend away therefrom to an edge 28 (also shown in cross-sectional profile in FIG. 5). Each sidewall 24 includes a main wall 26 and a rim 32 extending outwardly from the main wall 26. The rim 32 illustratively includes a jogged wall 34 connected to the main wall 26 and a rim wall 36 extending from the jogged wall 34.

The rim 32 is illustratively shaped to provide a jogged portion of the sidewall 24 for engagement with the basin 16 of the trunk 10. Each main wall 26 of each sidewall 24 is attached to and extends away from the top 22 of the lid 14 to an end 30. The jogged wall 34 illustratively attaches to the end 30 and extends away from the main wall 26 at an angle. The jogged wall 34 illustratively extends from the main wall 26 at an angle defined by the curvature of the end 30 to form a stepped portion as the rim 32. In the illustrative embodiment, the angle between the rim wall 36 and the jogged wall 34 is shown as approximately 90 degrees, and the angle between the main wall 26 and the jogged wall 34 as slightly greater than 90 degrees. It should be appreciated that in some embodiments the angles may be any angles suitable to provide a rim 32 for engagement with the basin 16.

Returning to FIG. 1, the latch assembly 18 includes a lower receiver 66 attached to the basin 16 and an upper receiver 68 attached to the lid 14. The lower receiver 66 is configured to articulate between a retracted position (as shown in FIG. 1) that is engaged with the upper receiver 68 to latch the trunk body 12, and an extended position (as shown in FIG. 2) that is disengaged with the upper receiver 68 to unlatch the trunk body 12. Lower receiver 66 includes an actuation lever 69 configured to be operated by the user to articulate the lower receiver 66 between the extended and retracted positions. In the illustrative embodiment, the latch handle 20 is mounted to the lid 14 through a lock tumbler assembly 60 of the trunk 10.

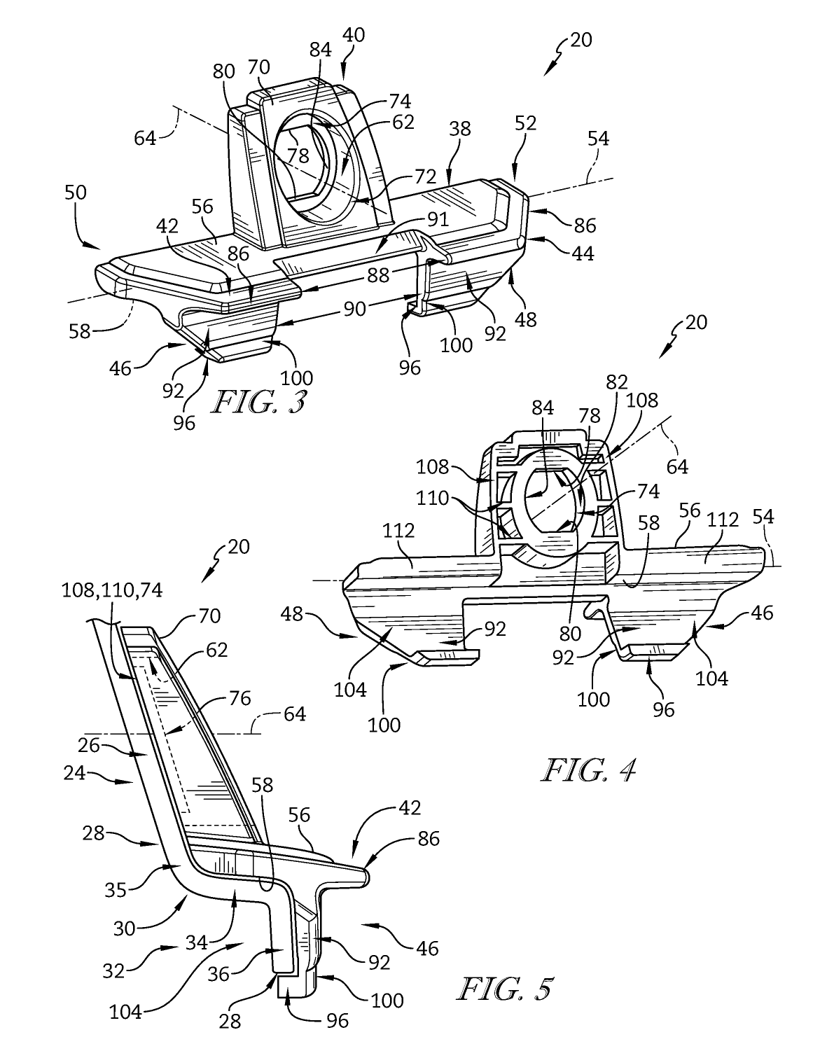

As mentioned above, the latch handle 20 is configured for grasping by a user's hand to permit operation of the lid 14. As shown in FIG. 3, the latch handle 20 illustratively includes an elongate body 38, a mast 40 extending from the body 38, a pair of handle wings 42, 44, and a pair of mounting flanges 46, 48. In the illustrative embodiment, the latch handle 20 is metallic and is formed of a single integral component by die casting. The entire handle 20 is also illustratively chrome plated by electroplating. In some embodiments, the latch handle 20 may be made of any suitable materials, formed of any or more component parts secured together, and/or made by any of casting, molding, machining, and/or any other suitable manufacturing techniques.

As shown in FIG. 3, the elongate body 38 extends along a longitudinal axis 54 between an end 50 and an end 52 positioned opposite the end 50. The body 38 illustratively includes a top surface 56 and a bottom surface 58 positioned opposite the top surface 56. The mast 40 illustratively extends outwardly from the top surface 56 of the body 38 in a direction away from the bottom surface 58.

The mast 40 illustratively includes a surface 70 having an opening 72 defined therein and a retainer wall 74 spaced apart from the surface 70. The mast 40 illustratively includes a cylindrical bore 62 defined therein along an axis 64. The cylindrical bore 62 illustratively extends through the mast 40 between the opening 72 and the retainer wall 74.

Referring to FIGS. 3-5, the retainer wall 74 includes a retainer opening 76 defined therein and shaped complimentary to a body of lock tumbler assembly 60 to prevent rotation therebetween. As described above, the handle 20 is illustratively coupled to the lid 14 via the lock tumbler assembly 60. In the illustrative embodiment, the retainer opening 76 receives the body of the lock tumbler assembly 60 therethrough. The retainer opening 76 is illustratively defined by a pair of opposing flat interior walls 78, 80 and a pair of opposing curved interior walls 82, 84 of the retainer wall 74. The retainer wall 74 is configured to contact a surface of the lock tumbler assembly 60 to fasten the latch handle 20 to the lid 14.

As described above, the handle wings 42, 44 extend from the body 22. Each of the handle wings 42, 44 is illustratively configured for grasping by a user's hand to operate the lid 14. In the illustrative embodiment, each handle wing 42, 44 includes a rounded outer edge 86 to provide a user-friendly hand interface.

The handle wings 42, 44 each illustratively extends from the body 38 along a plane that is generally parallel to the top surface 56 of the body 38. The handle wing 42 is illustratively disposed proximate to the end 50 of the body 38, and the handle wing 44 is illustratively disposed proximate to the opposite end 52 of the body 38. Each of the handle wings 42 and 44 is illustratively spaced apart from the other such that a gap 88 is defined therebetween. A front edge 91 of the body 38 at a location corresponding to the gap 88 illustratively has tapered thickness in a direction away from the mast 40 towards the gap 88.

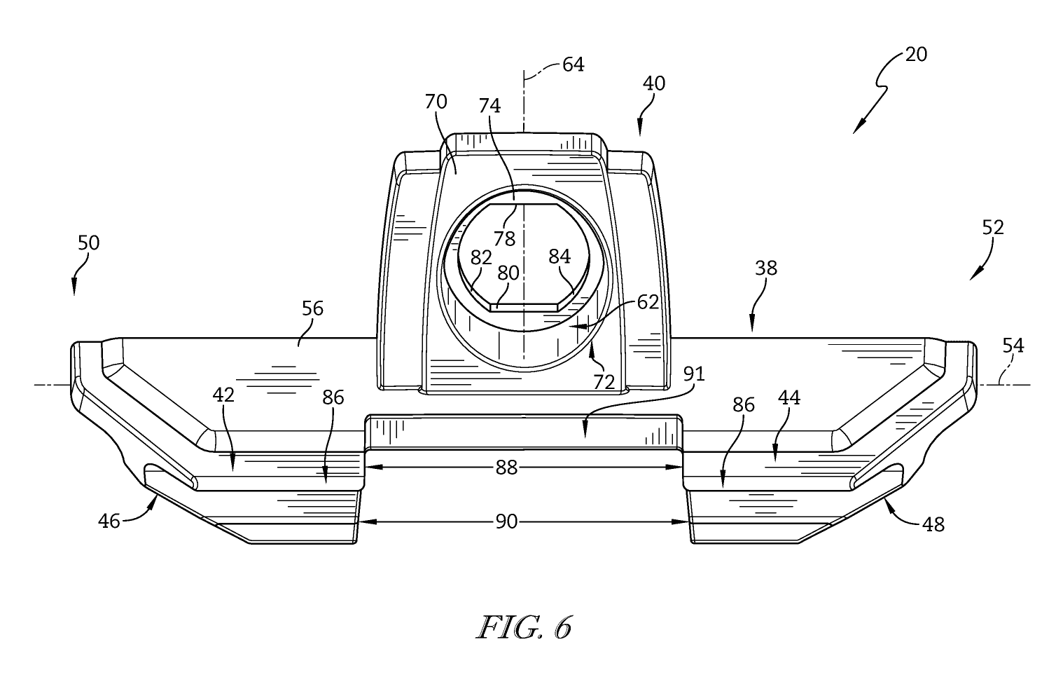

As shown in FIG. 6, one of the mounting flanges 46, 48 is disposed beneath each of the handle wing 42, 44, respectively. The mounting flange 46 is illustratively disposed proximate to the end 50 of the body 38, and the mounting flange 48 is illustratively disposed proximate to the opposite end 52 of the body 38. The mounting flanges 28a, 28b are illustratively positioned spaced apart from each other to define a gap 90 therebetween. The gap 90 is illustratively equal in length to the length of the gap 88, and each of gaps 88, 90 are illustratively sized to receive the upper receiver 68 of the latch assembly 18, as shown in FIG. 2.

Returning to FIGS. 3-5, each mounting flange 46, 48 respectively includes a leg 92 and a foot 96. The leg 92 of each respective mounting flange 46, 48 is illustratively attached to the bottom surface 58 of the body 38. The leg 92 of each respective mounting flange 46, 48 extends from the body 38 in a first direction to a respective end 100 thereof. Each foot 96 extends from the end 100 of the respective leg 92 in a second direction that is illustratively orthogonal to the first direction.

As shown in FIGS. 4 and 5, each of the mounting flanges 46, 48 respectively defines a channel 104 that is configured to receive the rim 32 of the lid 14 of the storage trunk 10. The bottom surface 58 of the body 38 and each respective leg 92 and foot 96 of the mounting flanges 46, 48 are arranged to form the channel 104 such that the channel 104 is sized complimentary to the rim 32 to engage with the rim 32 when received within the channel 104.

In the illustrative embodiment, when the rim 32 is received within the respective channel 104, the foot 96 of each mounting flange 46, 48 abuts the edge 28 of the sidewall 24, the leg 92 of each mounting flange 46, 48 abuts the rim wall 36, and the body 38 abuts the jogged wall 34. In some embodiments, the rim 32 may be received within the channel 104 such that any one or more of the foot 96 of each mounting flange 46, 48, the leg 92 of each mounting flange 46, 48, and the body 38, may be configured to be in close proximity with—but may not have contact with—the edge 28, the rim wall 36, and body 38, respectively.

Referring to FIG. 4, a rear perspective view shows portions of the mast 40 and body 38 are illustratively shaped to interface with the main wall 26 of the lid 14. The mast 40 illustratively includes a number of mast walls 108 that are connected to the retainer wall 74 by a number of support walls 110. The body 38 includes a back surface 112 illustratively positioned opposite the handle wings 44, 44 and extending with a curved transition from the top surface 56 to the bottom surface 58. The back surface 112 is illustratively shaped complimentary to the transition 35 of the lid 14.

Each of the mast walls 108, the support walls 110, and the retainer wall 74 is configured for engagement with the main wall 26 of the lid 14 when the rim 32 is received within the channel 104 of each of the mounting flanges 46, 48. In the illustrative embodiment, when the rim 32 is received within the channel 104, the mast walls 108, the support walls 110, and the retainer wall 74 each abuts the main wall 26 of the lid 14, and the back surface 112 of the body abuts the end 30 of the main wall 26.

In some embodiments, the rim 32 may be received within the channel 104 such that any one or more of the mast walls 108, the support walls 110, the retainer wall 74, and the back surface 112 may be configured to be in close proximity with—but may not have contact with—the main wall 26. In some embodiments, a cushion formed of resilient material, for example rubber, may be positioned between the lid 14 and the latch handle 20 to dampen engagement therebetween.

In the illustrative embodiment, the lid 14 illustratively has a curvature along the direction of the axis 54 (into the page as shown in FIG. 5). The portions of the mast 40, body 38, and mounting flanges 46, 48 that interface with the lid 14 when the rim 32 is received within the channel 104 are illustratively shape to have curvature complimentary to that of the lid 14 along the direction of the axis 54.

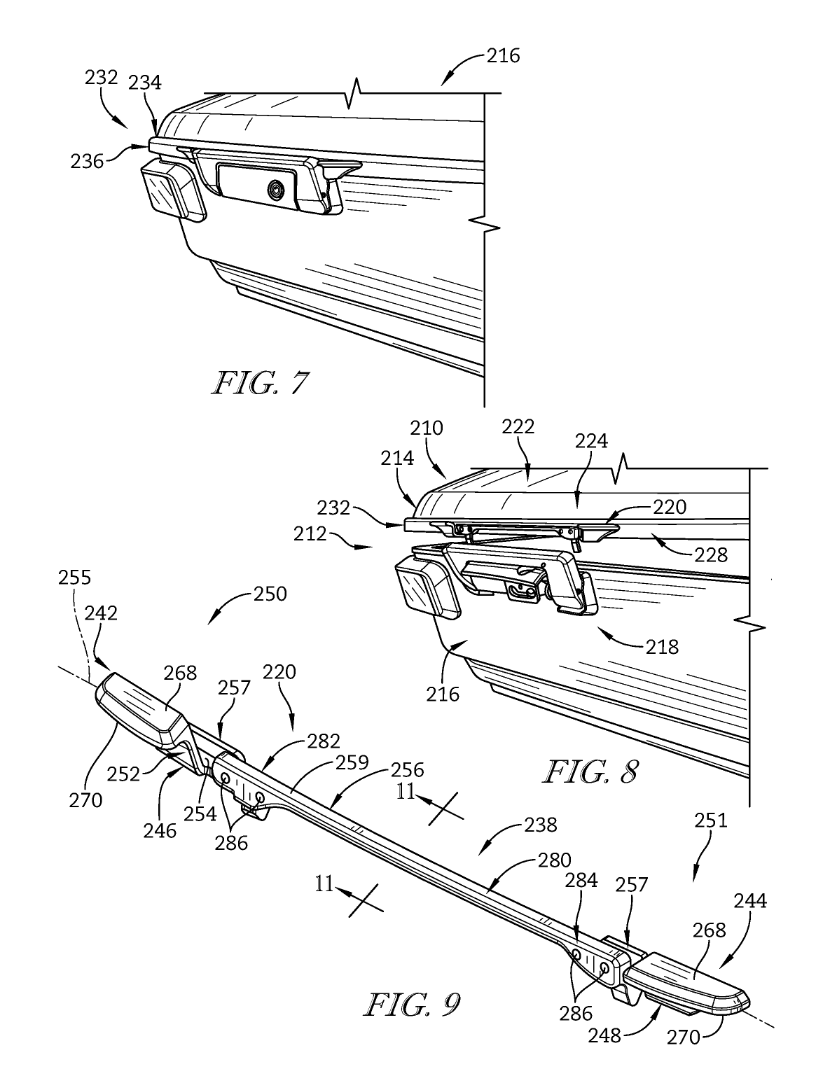

Referring now to the illustrative embodiment as shown in FIGS. 7 and 8, a latchable vehicle storage trunk 210 for securely storing items includes a trunk body 212 having a lid 214 and a basin 216, a trunk latch assembly 218 having a lower receiver 274 for latching the lid 214 and the basin 216 together, and a latch handle 220 attached to the lid 214. The latch handle 220 provides an interface for a user's hand to grasp to move the lid 214 between closed position (as shown in FIG. 7) and an open position (as shown in FIG. 8).

As suggested in FIG. 8, a user can unlatch the lower receiver 274 of the latch assembly 218, grasp the latch handle, and move the lid 214 between the open and closed positions via the latch handle 220. A user thus can open and close the latchable vehicle storage trunk 210 without having to touch parts other than the latch handle 220 such as, for example, the lid 214, which may be painted, polished, and/ or otherwise preferable to leave untouched. The latch handle 220 provides ease of operating the trunk 210 and permits one-handed operation while minimizing the risk of scratches, smudges, and other contact related issues to other components of trunk 210.

As shown in FIGS. 7, 8, and 12, the lid 214 includes a top 222 and a number of sidewalls 224. The sidewalls 224 are each illustratively attached to the top 222 and extend away therefrom to form an edge 228. Each sidewall 224 includes a main wall 226 having an end 230, and a rim 232 connected to the end 230 and extending away from the main wall 226. The rim 232 illustratively includes a jogged wall 234 attached to the end 230 of the main wall and a rim wall 236 connected to the jogged wall 234.

As shown in FIGS. 7 and 8, the latch handle 220 is mounted to the lid 214 of the trunk 210. The latch handle 220 is configured for grasping by a user's hand to permit movement of the lid 214. The latch handle 220 illustratively includes an elongate body 238 and a pair of handle wings 242, 244 extending from the body 238. In the illustrative embodiment, the latch handle 220 is metallic and is formed of a single integral component by injection molding. In some embodiments, the latch handle 220 may be plastic and/ or any other suitable material, may be formed of one or more component parts secured together, and/or made by any of casting, molding, machining, and/ or any other suitable manufacturing techniques.

As shown in FIG. 9, the elongate body 238 extends between an end 250 and an end 251 along a longitudinal axis 255. The body 138 includes a beam 256 having a top surface 259 and a pair of mounting flanges 246, 248 respectively disposed proximate to the ends 250, 251 of the body 238. The mounting flanges 246, 248 are illustratively positioned spaced apart from each other and connected to opposite ends of the beam 256 such that the beam 256 is illustratively positioned in a generally central arrangement along the axis 255 of the body 238.

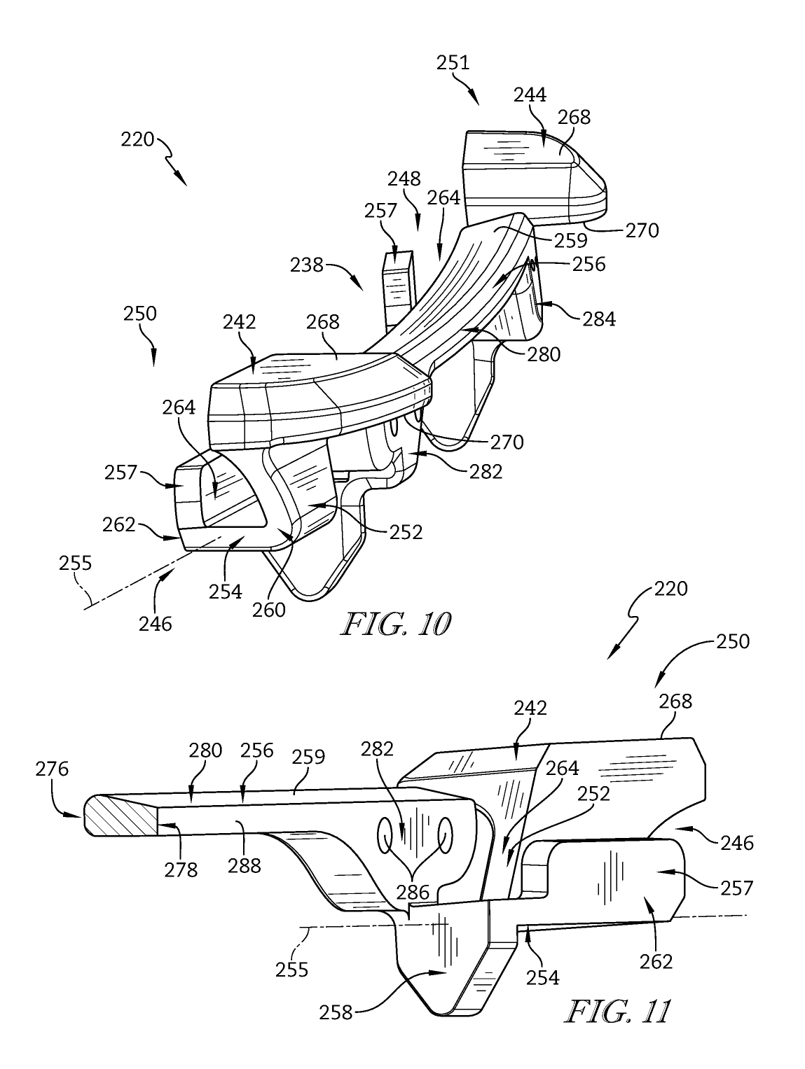

As shown in FIGS. 10, each mounting flange 246, 248 includes a leg 252, a foot 254 connected to the leg 252, and a toe 257 connected to the foot 254. The foot 254 of each mounting flange 246, 248 has a front end 260, and a rear end 262 opposite the front end 260. The leg 252 of each mounting flange 246, 248 is illustratively connected to the front end 260 of the respective foot 254 and extends vertically therefrom. The toe 257 of each mounting flange 246, 248 is illustratively connected to the rear end 262 of its respective foot 254 and extends therefrom parallel to the leg 252.

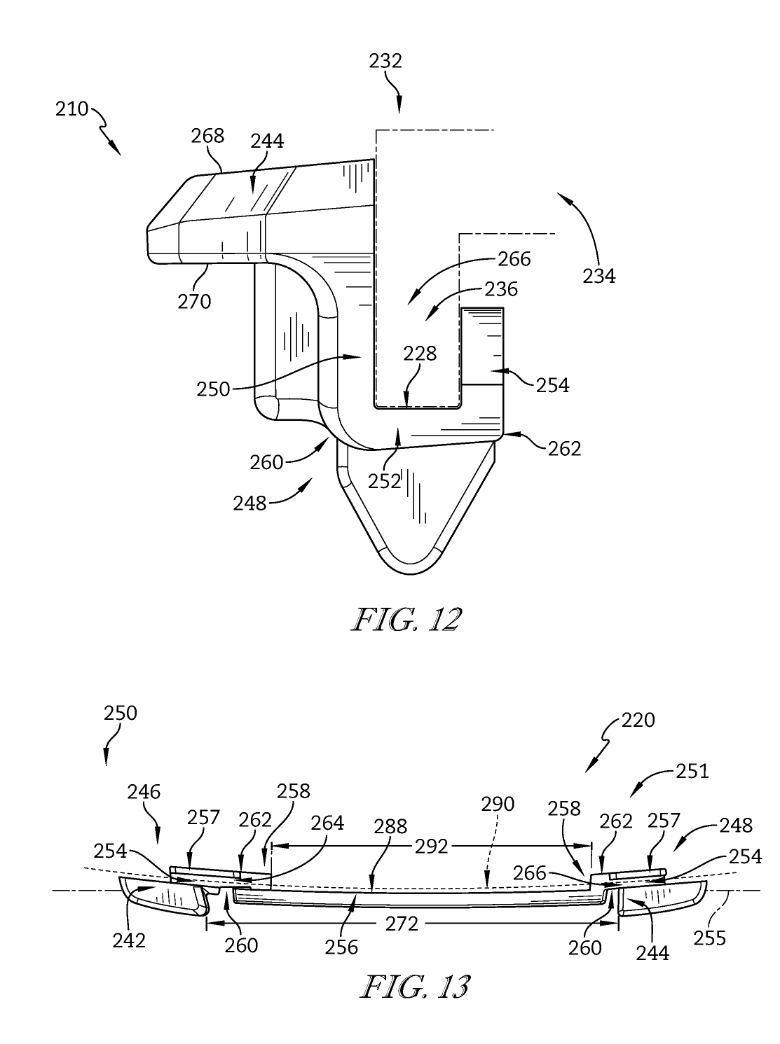

The mounting flanges 246, 248 each define a channel 264 configured to receive the rim 232 of the lid 214 for fixing the latch handle 220 to the lid 214. As shown in FIGS. 11 and 12, the leg 252, the foot 254, and the toe 257 of each mounting flange 246, 248 are illustratively arranged to form the channel 264 to be sized complimentary to the rim 232 to engage the rim 232 when received therein.

As shown in FIG. 12, when the rim 232 is received within the channel 264, each leg 252 and each foot 254 of the respective mounting flange 246, 248 abuts the rim wall 236, and the toe 257 of the respective mounting flange 246, 248 abuts the edge 228 of the side wall 224. In some embodiments, the rim 232 may be received within the channel 264 such that any one or more of the leg 252, the foot 254, and the toe 257 of the respective mounting flange 246, 248 may be configured to be in close proximity to—but may not have contact with—the rim wall 236 and edge 228, respectively. In some embodiments, a damper, for example, resilient material such as rubber, may be positioned between the lid 214 and the latch handle 220 to provide soft engagement therebetween.

As shown in FIGS. 10-12, the leg 252 of each mounting flange 246, 248 is illustratively disposed beneath and attached to the respective handle wing 242, 244. The handle wings 242, 244 illustratively include a top side 268 and a bottom side 270 opposite the top side 268. The leg 252 of each mounting flange 246, 248 illustratively extends from the bottom side 270 of the respective handle wing 242, 244 in a downward direction.

As shown in FIG. 13, the handle wings 242, 244 are illustratively disposed spaced apart from each other to define a gap 272. The gap 272 is sized to receive the lower receiver 274 of the trunk latch assembly 218 therebetween for engagement with the top surface 259 of the beam 256 to secure the trunk 10. The top surface 259 of the beam 256 is configured for engagement by the latch assembly 218 to secure the lid 214 in the closed position.

As shown in FIGS. 10 and 11, the beam 256 is attached to an inner end 258 of each foot 254 of the mounting flanges 246, 248. Each inner end 258 of each foot 254 of the mounting flanges 246, 248 are illustratively spaced apart from the other such that a gap 292 is defined therebetween. The beam 256 includes strut 280 extending parallel to the axis 255 and a pair of gussets 282, 284 connected to opposite ends of the strut 280. The strut 280 includes a front edge 276 and a rear edge 278 opposite the front edge 276, the front edge 276 illustratively having greater vertical thickness than the rear edge 278 such that the top surface 259 is sloped for engagement with the lower receiver 274 of the trunk latch assembly 218.

Each gusset 282, 284 extends from the strut 280 to connect with respective mounting flanges 246, 246. Each gusset 282, 284 illustratively connects with the foot 254 of the respective mounting flange 246, 248 at the inner end 258 thereof. The gussets 282, 284 each illustratively include attachment holes 286 defined therethrough to receive fasteners for attaching the latch handle 220 to the lid 214. The beam 256 includes a rear surface 288 configured to engage the lid 214 to fasten the latch handle 220 to the lid 214.

In the illustrative embodiment as shown in FIG. 13, the rear surface 288 of the beam 256 and the surfaces of the mounting flanges 246, 248 that define the channels 264 are shaped complimentary to a curvature (represented by line 290) of an outer surface of the rim wall 236 of the lid 214. In the illustrative embodiment, the curvature 290 is embodied as generally consistent along the length of the lid 214 corresponding to engagement with the latch handle 220 along the axis 255. In some embodiments, the curvature 290 may have any suitable shape and/or consistency for engagement between the lid 214 and the latch handle 220.

In the foregoing descriptions of the trunks 10, 210, the lower latch receiver 66 and/or portions of the trunk latch assemblies 18, 218 are illustratively attached to their respective basins 16, 216 while the latch handles 20, 220 and/ or the upper latch receiver 68 are illustratively attached to their respective lids 18, 214. It should be appreciated that in some embodiments, the trunks 10, 210 may be arranged such that the lower latch receiver 66 and/ or portions of the trunk latch assemblies 18, 218 may be attached to their respective lids 18, 214 while portions of the latch handles 20, 220 and/ or the upper latch receiver 68 are attached to their respective basins 16, 216, and/or the trunks 10, 210 may have any other positional arrangement of components such that the trunk 10, 210 are selectively securable.

While the disclosure has been illustrated and described in detail in the drawings and foregoing description, such an illustration and description is to be considered as exemplary and not restrictive in character, it being understood that only illustrative embodiments have been shown and described and that all changes and modifications that come within the spirit of the disclosure are desired to be protected.

There are a plurality of advantages of the present disclosure arising from the various features of the apparatus, system, and method described herein. It will be noted that alternative embodiments of the apparatus, system, and method of the present disclosure may not include all of the features described yet still benefit from at least some of the advantages of such features. Those of ordinary skill in the art may readily devise their own implementations of the apparatus, system, and method that incorporate one or more of the features of the present invention and fall within the spirit and scope of the present disclosure.

What is claimed is:

1. A handle for a vehicle storage bin, the handle comprising:
an elongate body extending between a first end and a second end and having a top surface and a bottom surface opposite the top surface,
a mast extending from the top surface of the body at a location between the first and second ends, the mast including an attachment hole extending therethrough, and
a handle wing extending from the body, the handle wing being configured for grasping by a hand of a user to open and close the vehicle storage bin.

2. The handle of claim 1, further comprising a flange extending from the bottom surface of the body proximate to the first end of the body.

3. The handle of claim 2, wherein the flange includes a leg extending from the bottom surface of the body in a first direction and a foot extending from an end of the leg in a second direction that is orthogonal to the first direction.

4. The handle of claim 3, wherein the flange defines a receptacle sized to receive a rim of a lid of the vehicle storage bin.

5. The handle of claim 3, further comprising a second flange including a leg extending from the bottom surface of the body in the first direction and a foot extending from an end of the leg of the second flange in the second direction.

6. The handle of claim 5, wherein the flange is a first flange and the second flange extends from the body proximate to the second end of the body spaced apart from the first flange.

7. The handle of claim 6, wherein an opening sized to receive an upper receiver of a latch of the vehicle storage bin is defined between the first flange and the second flange.

8. The handle of claim 1, wherein the attachment hole is defined by a pair of opposing flat surfaces of the mast and a pair of opposing curved surfaces of the mast.

9. The handle of claim 8, wherein the attachment hole is configured to receive a lock tumbler assembly of the vehicle storage bin.

10. A handle for a vehicle storage bin, the handle comprising:
an elongate body extending between a first end and a second end and defining a first axis,
a receptacle defined by the body, and
a handle wing extending from the body at the first end, the handle wing being configured for engagement by a hand of a user to open and close the vehicle storage bin.

11. The handle of claim 10, wherein the body includes a flange that defines the receptacle.

12. The handle of claim 11, wherein the flange includes a leg extending from a bottom side of the handle wing in a first direction and a foot extending from an end of the leg in a second direction that is orthogonal to the first direction.

13. The handle of claim 12, wherein the flange includes a toe extending from the leg in a third direction parallel to the first direction and the receptacle is configured to receive a rim of a lid of the vehicle storage bin.

14. The handle of claim 11, wherein the flange is a first flange positioned proximate to the first end, and the body includes a second flange extending from the body and positioned proximate to the second end of the body.

15. The handle of claim 10, wherein the body includes a central beam extending between the first and second ends, the central beam having an upper surface that is configured for engagement by a lower latch receiver of the vehicle storage bin to block opening of the vehicle storage bin.

16. The handle of claim 15, wherein the central beam has a tapered cross-section when viewed along the first axis.

17. The handle of claim 15, wherein the central beam includes an attachment hole extending therethrough.

18. The handle of claim 15, wherein the central beam includes a rear surface having a curvature shaped to engage an outer surface of a lid of the vehicle storage bin.

19. The handle of claim 18, wherein the handle wing includes a rear surface having a curvature shaped to engage the outer surface of the lid of the vehicle storage bin.

20. A latchable vehicle storage truck comprising:
a trunk body including a lid and basin together defining a bottom wall, sidewalls, and a top wall,
a trunk latch assembly, and
a latch handle including
an elongate body extending between a first end and a second end, the body defining an attachment hole penetrating therethrough,
a handle wing extending from the elongate body at the first end thereof and configured for grasping by a hand of a user to open and close the trunk body, and
a mounting flange extending from the elongate body beneath the handle wing.
